(19) United States
(12) Patent Application Publication
(10) Pub. No.: US 2015/0242879 A1
(43) Pub. Date: Aug. 27, 2015

(54) METHOD FOR PROVIDING DIGITALIZED CUMULATIVE COUPON SERVICE AND SYSTEM FOR SAME

(71) Applicant: LINE Corporation, Tokyo (JP)

(72) Inventors: Hyun Chul LEE, Seongnam-si (KR); JiHan KIM, Seongnam-si (KR); Juho CHO, Seongnam-si (KR)

(21) Appl. No.: 14/706,399

(22) Filed: May 7, 2015

Related U.S. Application Data
(63) Continuation of application No. PCT/KR2013/009233, filed on Oct. 16, 2013.

(30) Foreign Application Priority Data
Nov. 7, 2012 (KR) 10-2012-0125563

(51) Int. Cl. G06Q 30/02

(52) U.S. Cl. CPC G06Q 30/0226

(57) ABSTRACT

A method for providing a digitalized cumulative coupon service and a system for the same are disclosed. The method for providing a cumulative coupon service can comprise the steps of: accumulating mileage provided by a franchise into a coupon related to the franchise for a user; and sharing the coupon or mileage with a person set by the user.

### CROSS-REFERENCE TO RELATED APPLICATIONS

This application is a U.S. continuation application filed under 35 USC 111(a) claiming benefit under 35 USC 120 and 365(c) of PCT application PCT/KR2013/009233, filed on Oct. 16, 2013, and the benefit of priority from the prior Korean Patent Application No. 10-2012-0125563, filed on Nov. 7, 2012, the entire contents of which are incorporated herein by reference.

### FIELD

Embodiments of the present invention relate to a method and system for providing a cumulative coupon service.

### BACKGROUND

In general, a mileage service refers to a marketing method that may provide a predetermined coupon in response to a purchase of a product being sold at a store and may provide a user with a predetermined product being sold at the corresponding store free of charge if the user collects a predetermined number of coupons.

However, when a user loses a coupon or when a fault occurs in the coupon, the user may not receive a reward. Further, managing a coupon is not easy and thus, coupons are being used at a relatively low frequency. In addition, accumulation, that is, collection as a coupon at a store may simply arouse a user's purchase desire, however, may not be used for marketing through an advanced level of customer management such as aggressively promoting a coupon and diversifying types of coupons.

Korean Laid-Open Publication No. 10-2006-0034983, published on Apr. 26, 2006, discloses a technology for providing a coupon management service to a mobile communication terminal in interaction with a point of sales management (POS) system of a store.

However, a mileage service according to the related art simply maintains and manages a current accumulation state of an individual and a significantly limited service is provided. Accordingly, there is a need for a further active and efficient mileage service model embracing the information age.

### SUMMARY

Embodiments provide a method and system for providing a cumulative coupon service that allows a user to share a coupon and a stamp of the user with a friend of the user.

Embodiments also provide a method and system for providing a cumulative coupon service that may expand a service by registering various types of coupons.

According to an embodiment of the present invention, there is provided a method of providing a cumulative coupon service, the method including accumulating mileage provided from a franchised store into a coupon associated with the franchised store for a user; and sharing the coupon or the mileage with a target user set by the user.

According to an aspect, the sharing of the coupon or the mileage may includes transmitting the coupon or the mileage to the target user selected from a buddy list registered to a messenger in interaction with a messenger platform; and accumulating a mileage accumulated in the received coupon or the received mileage into a coupon of the target user in response to the target user receiving the coupon or the mileage through the messenger.

According to another aspect, the sharing of the coupon or the mileage may include outputting the coupon or the mileage in a multi-dimensional code on a terminal of the user; and accumulating the coupon or the mileage output in the multi-dimensional code into a coupon of the target user in response to the multi-dimensional code input through an application installed in a terminal of the target user.

According to still another aspect, the cumulative coupon service providing method may further include issuing an admin code associated with the franchised store. The accumulating of the mileage may include accumulating the mileage into the coupon of the user in response to the admin code input through an application installed in a terminal of the user.

According to still another aspect, the cumulative coupon service providing method may further include issuing a multi-dimensional code associated with the mileage. The accumulating of the mileage may include accumulating the mileage into the coupon of the user in response to the multi-dimensional code input through an application installed in a terminal of the user.

According to still another aspect, the issuing of the multi-dimensional code may include outputting the multi-dimensional code on a receipt in interaction with a receipt output system of the franchised store.

According to still another aspect, the cumulative coupon service providing method may further include issuing identification information of the user. The accumulating of the mileage may include accumulating the mileage into the coupon of the user recognized based on the identification information in response to the identification information input through an admin page associated with the franchised store.

According to still another aspect, the cumulative coupon service providing method may further include providing a franchised store list in which the mileage is accumulated through an application installed in a terminal of the user; and providing current state information or details information about the mileage for each franchised store included in the franchised store list.

According to still another aspect, the cumulative coupon service providing method may further include providing statistical information about the coupon or the mileage through an admin page associated with the franchised store.

According to still another aspect, the cumulative coupon service providing method may further include registering a coupon associated with the franchised store through an admin page associated with the franchised store.

According to still another aspect, the registering of the coupon associated with the franchised store may include setting any one coupon type among a basic type of giving a reward in response to the mileage reaching an accomplishment level or a threshold level before the achievement level through the admin page, a customized type of applying a product image associated with the franchised store as a background page of the coupon or the mileage, and an advertising type of providing advertisement content associated with the franchised store through the coupon.

According to an embodiment of the present invention, there is provided a system for providing a cumulative coupon service, the system including an accumulator configured to accumulate a mileage provided from a franchised store into a coupon associated with the franchised store for a user; and a sharer configured to share the coupon or the mileage with a target user set by the user.

### BRIEF DESCRIPTION OF THE DRAWINGS

FIGS. 1 through 4 illustrate examples of a coupon accumulation scenario according to an embodiment of the present invention;

FIGS. 5 through 9 illustrate a process of registering a coupon of a franchised store according to an embodiment of the present invention;

FIGS. 10 through 12 are flowcharts illustrating a process of accumulating a mileage into a coupon of a user according to an embodiment of the present invention;

FIGS. 13 and 14 illustrate a process of transferring, by a user, an accumulated coupon or mileage to a friend according to an embodiment of the present invention;

FIG. 15 is a flowchart illustrating a process of using, by a user, an accumulated coupon or mileage according to an embodiment of the present invention; and

FIGS. 16 and 17 illustrate a configuration of a cumulative coupon service system according to an embodiment of the present invention.

### DESCRIPTION OF EMBODIMENTS

Hereinafter, embodiments of the present invention will be described in detail with reference to the accompanying drawings.

Embodiments of the present invention provide a digitalized cumulative coupon service for providing the convenience in coupon management on the side of a customer and providing the convenience in coupon distribution and store promotion on the side of an owner of a franchised store.

The term “mileage” has a virtual currency function provided for promotion of a store or provided based on actual use results of a customer and may be accumulated in a variety of forms such as points and stamps. Hereinafter, a service model for accumulating stamps into a virtual coupon issued from a franchised store based on actual use results of a customer will be described in detail as a representative example of mileage.

Further, the term “multi-dimensional code” indicates an information providing means to record and provide information, such as a quick response (QR) code, a data matrix, and a maxi code in addition to a simple serial number and a barcode. Hereinafter, the QR code will be described as a representative example of the multi-dimensional code.

Although a mobile phone is described as a terminal used by a user, the present invention is not limited thereto. Any type of terminals available in a mobile environment such as a smartphone and a tablet may be applicable to the terminal used by the user.

The present embodiment provides a function capable of easily accumulating a stamp of a franchised store into a virtual cumulative coupon owned by a user, which may be embodied using a variety of methods.

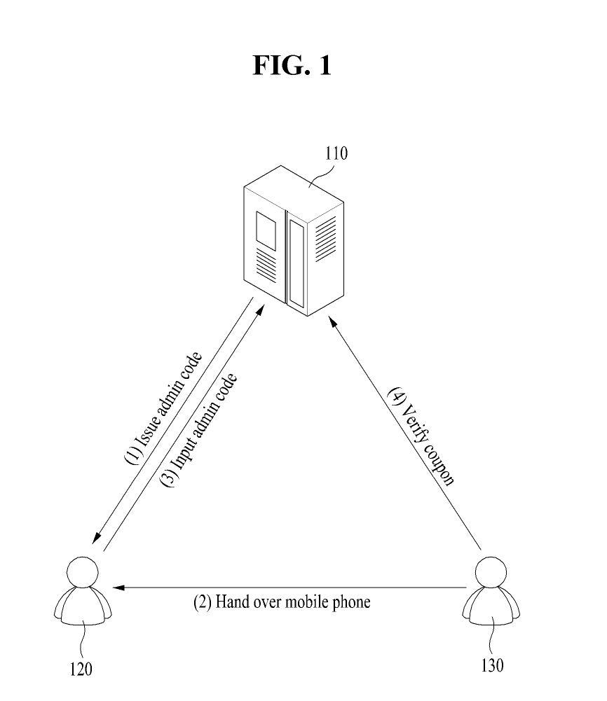

FIGS. 1 through 4 illustrate four scenarios for coupon accumulation.

An example of a coupon accumulation scenario will be described with reference to FIG. 1.

(1) When a store owner 120 of a franchised store registers a cumulative coupon available at the franchised store to a cumulative coupon service system (hereinafter, a coupon server) 110, the coupon server 110 issues an admin code to the store owner 120.

(2) A user 130 visits the franchised store and hands over a mobile terminal, for example, a mobile phone to the store owner 120 for payment.

(3) The store owner 120 may add a stamp by inputting the admin code into a coupon of the franchised store owned by the user 130 through an exclusive coupon service application (hereinafter, a coupon management App) installed in the mobile phone of the user 130.

(4) The user 130 may verify stamps accumulated into the coupon of the user 130 through the coupon management App installed in the mobile phone of the user 130.

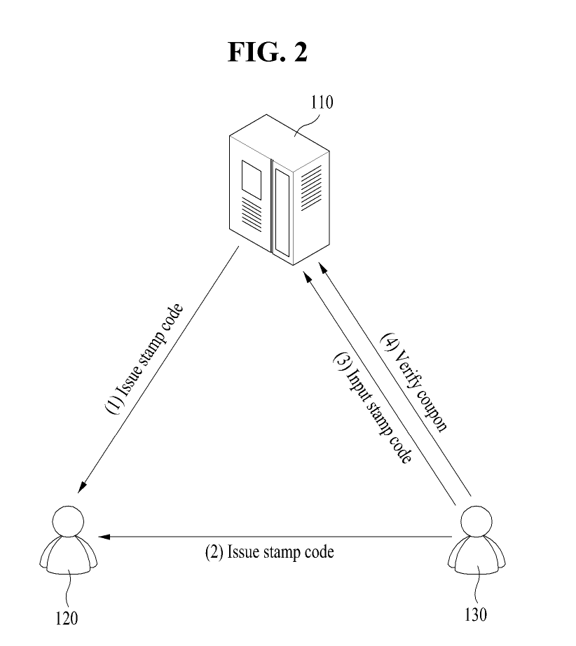

Another example of a coupon accumulation scenario will be described with reference to FIG. 2.

(1) When the store owner 120 of the franchised store registers a cumulative coupon available at the franchised store of the store owner 120 to the coupon server 110, the coupon server 110 issues a stamp code to the store owner 120. Here, the stamp code includes a QR code and the store owner 120 prints the stamp code in a form of, for example, a sticker and issues the printed stamp code to customers. A place of business associated with the coupon server 110 may directly provide a stamp output and delivery service to a store owner having a difficulty in outputting a QR code at a corresponding franchised store.

(2) When the user 130 visits the franchised store and makes a payment, the store owner 120 issues a required number of stamps to the user 130.

(3) The user 130 may add a stamp issued from the store owner 120 into the coupon of the user 130 by inputting a QR code of the stamp through a coupon management App installed in the mobile phone of the user 130.

(4) The user 130 may verify stamps accumulated into the coupon of the user 130 through the coupon management App installed in the mobile phone of the user 130.

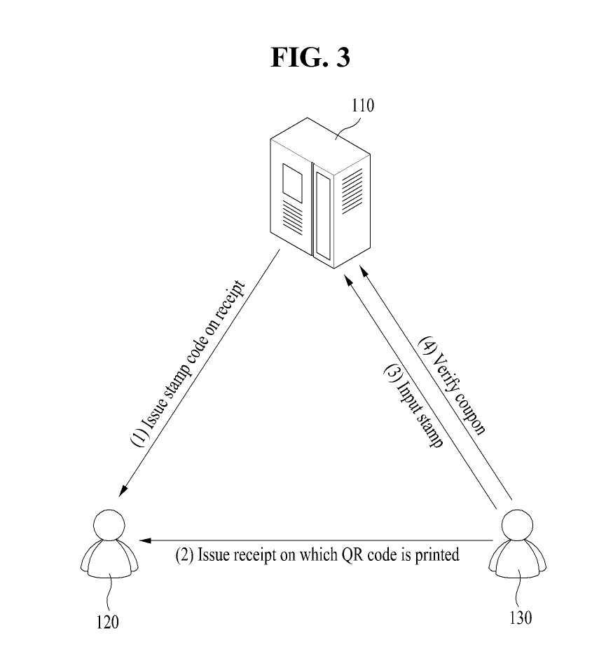

Another example of the coupon accumulation scenario will be described with reference to FIG. 3.

(1) When the store owner 120 of the franchised store registers a cumulative coupon available at the franchised store of the store owner 120 to the coupon server 110, the coupon server 110 prepares interaction with a receipt output system of the franchised store. When the user 130 visits the franchised store and makes a payment, a stamp code, that is, a QR code available as a coupon is printed on a receipt output from the receipt output system through interaction between the coupon server 110 and the receipt output system.

(2) The store owner 120 issues the receipt on which the QR code is printed to the user 130.

(3) The user 130 may add a corresponding stamp into the coupon of the user 130 by inputting the QR code of the receipt issued from the store owner 120 through a coupon management App installed in the mobile phone of the user 130.

(4) The user 130 may verify stamps accumulated into the coupon of the user through the coupon management App installed in the mobile phone of the user 130.

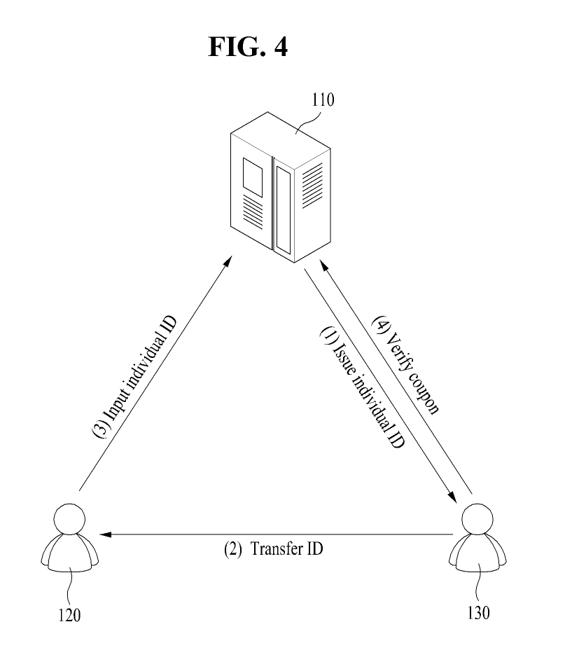

Another example of the coupon accumulation scenario will be described with reference to FIG. 4.

(1) When the user 130 installs a coupon management App in the mobile phone of the user 130, the coupon server 110 issues an individual identifier (ID) for identifying the user 130. In addition, a QR code or a barcode may be used as ID information.

(2) When the store owner 120 of the franchised store registers a cumulative coupon available at the franchised store of the store owner 120 to the coupon server 110, the coupon server 110 provides an admin code for coupon accumulation to the store owner 120. When the user 130 visits the franchised store and makes a payment, the user 130 transfers the individual ID issued from the coupon server 110 to the store owner 120.

(3) The store owner 120 may add a stamp to a coupon of the franchised store owned by the user 130 by inputting the individual ID of the user 130 through an admin page provided from the coupon server 110.

(4) The user 130 may verify stamps accumulated into the coupon of the user 130 through the coupon management App installed in the mobile phone of the user 130.

As described above, according to embodiments, it is possible to accumulate a stamp of a franchised store into a cumulative coupon owned by a user using a variety of methods.

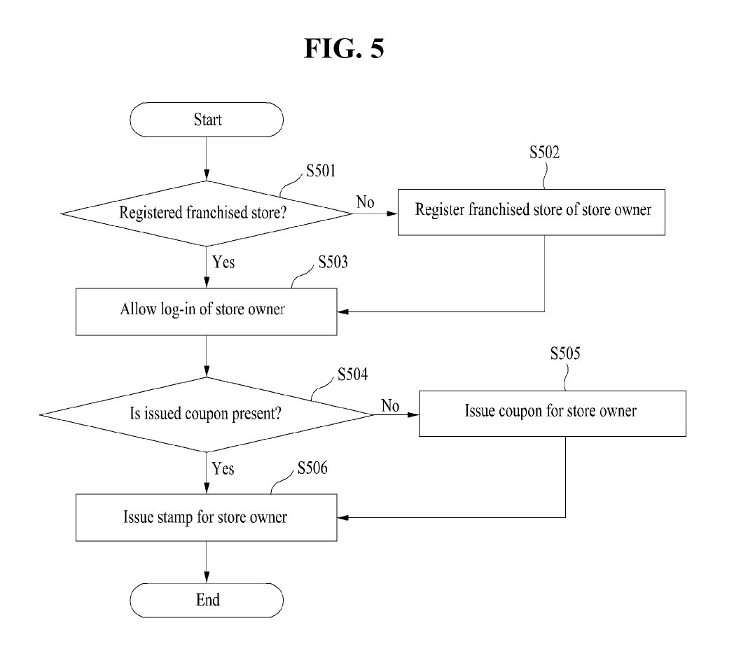

A method of providing a cumulative coupon service according to an embodiment of the present invention will be described with reference to FIGS. 5 through 15. Operations included in the cumulative coupon service providing method will be described by a coupon server, which will be described below.

FIG. 5 is a flowchart illustrating a method of registering a coupon of a franchised store. The coupon of the franchised store may be registered by a store owner corresponding to an administrator.

In operations S501 through S503, a coupon server may allow log-in of a store owner in a state in which a franchised store of the store owner is registered to a system through a predetermined contract procedure. The store owner may approach the coupon server in a PC environment or a mobile environment such as a smartphone.

In operations S504 and S505, the coupon server may provide the logging-in store owner with an admin page for coupon registration, and may receive required information from the store owner through the admin page and issue a coupon of the franchised store.

In operation S506, when a coupon issuance of the franchised store is completed, the coupon server may issue a stamp for mileage collection, that is, accumulation into the coupon. Here, the stamp may include a QR code and may be printed in a form of a sticker and be issued to customers at the franchised store. For management and validity check of a stamp, the coupon server may issue a QR code including different types of information about each stamp and may issue a large number of stamps per issuance. In this example, when all of the issued stamps are used at the franchised store, the coupon server may issue an additional stamp in response to a request of the store owner.

In addition, according to a variety of methods described in the four scenarios, the coupon server may issue an admin code of the store owner, may issue an individual ID of a user, or may issue a QR code on a receipt in interaction with a receipt output system of the franchised store.

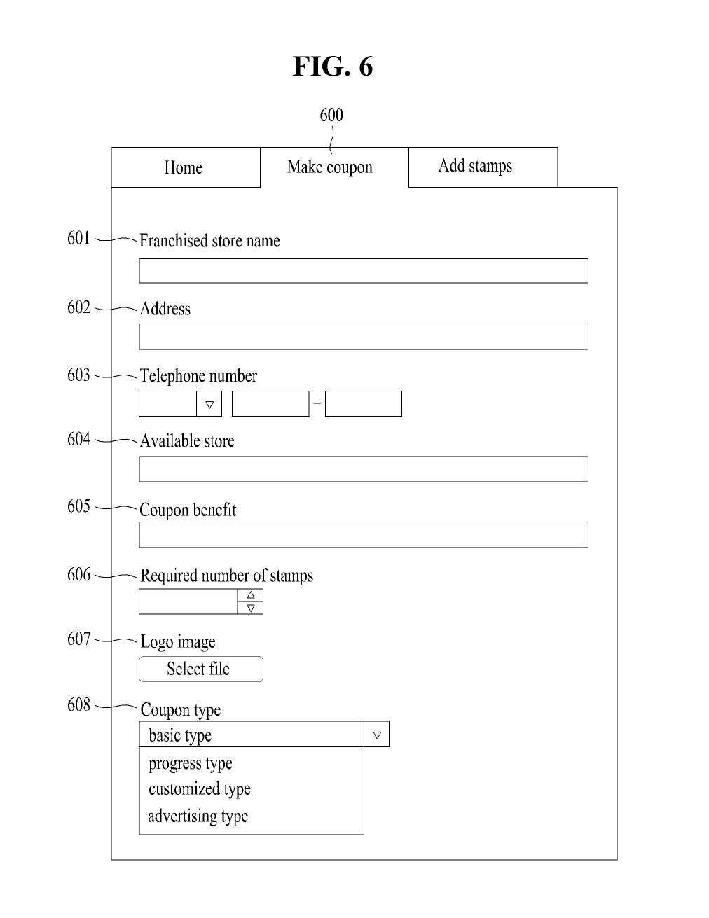

FIG. 6 illustrates an example of an admin page for coupon registration.

A coupon server may provide the admin page 600 for coupon registration in response to a request from a store owner. Here, a franchised store name 601, an address 602 and a telephone number 603 of a franchised store, an available store 604, a coupon benefit 605, the number of stamps 606 required for benefit, a logo image 607 of the franchised store or a product image associated with the benefit, and a coupon type 608 may be input into the admin page 600.

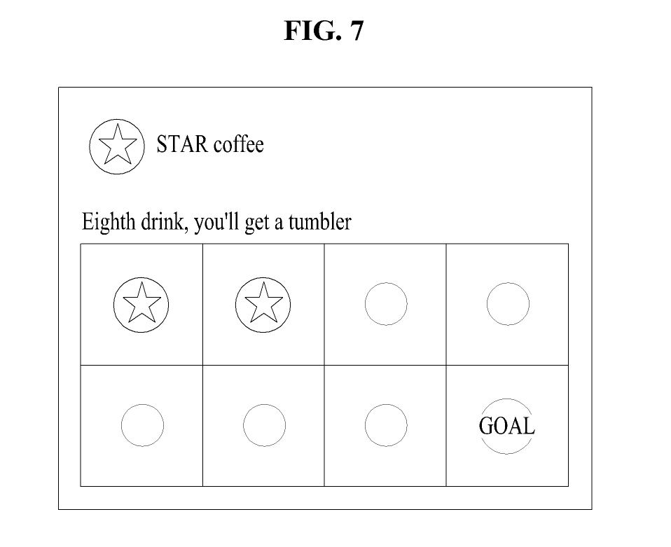

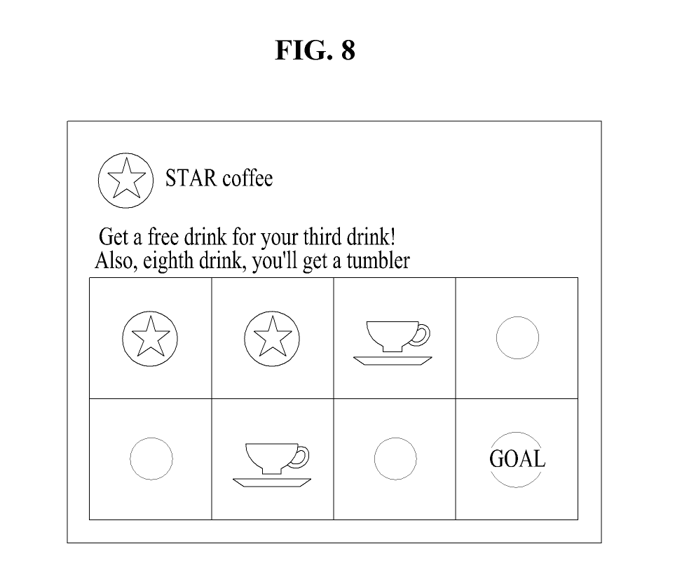

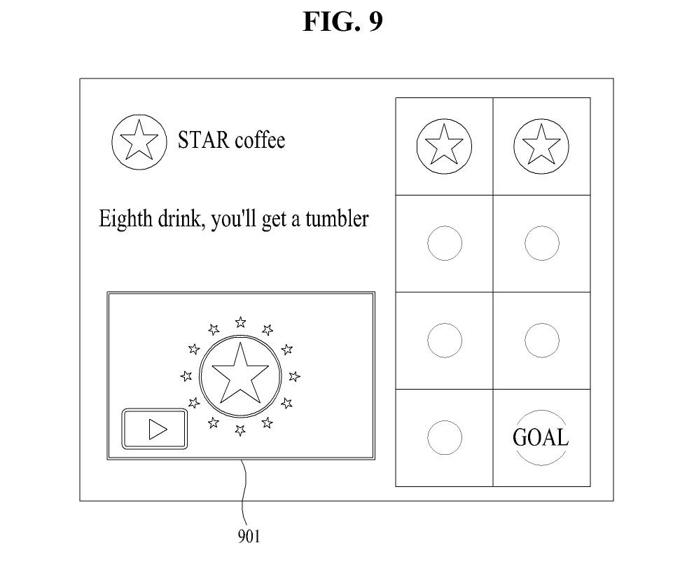

A type of a coupon may include a basic type of giving a reward when the number of stamps determined by the store owner is collected, a progress type of giving an intermediate reward every time the number of stamps reaches a threshold, a customized type of displaying a background image of a coupon and a stamp using a product image of the franchised store, and an advertising type of providing advertisement content such as a logo image or a video of the franchised store through the coupon. Referring to FIG. 7, a basic type coupon may be configured to provide a benefit when the total number of stamps is accumulated into a coupon. Referring to FIG. 8, a progress type coupon may be configured to provide a benefit intermittently during accumulating the total number of stamps into the coupon, for example, every time 3 stamps among 8 stamps are collected, that is, accumulated and to provide another benefit when the total number of stamps is accumulated. A customized type coupon may be configured to provide a benefit when a product image is completed by constructing a stamp as a puzzle piece of the product image and by accumulating stamps. Referring to FIG. 9, an advertising type coupon may be configured to contain a logo image or a video advertisement 901 of a franchised store on a coupon.

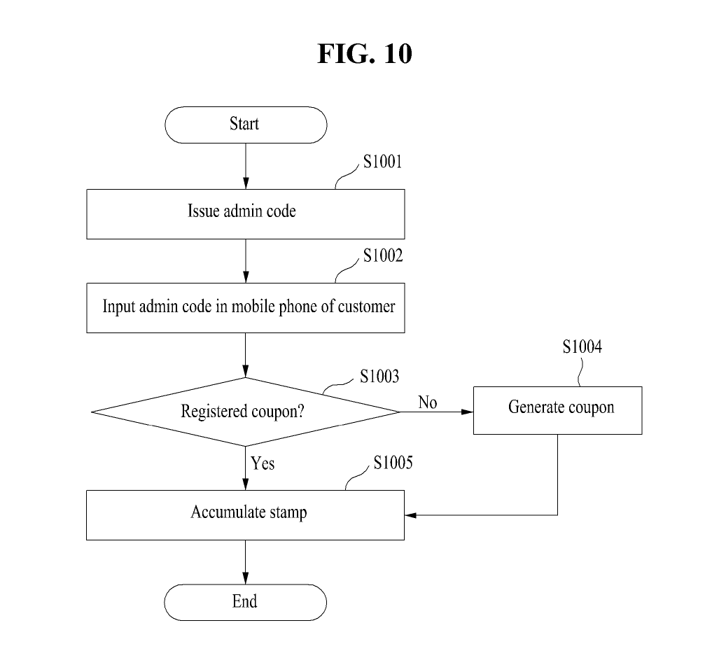

FIG. 10 is a flowchart illustrating a method of accumulating a coupon using an admin code of a store owner.

In operation S1001, once a coupon issuance by the store owner is completed, a coupon server may issue an admin code required for coupon accumulation. To accumulate a stamp provided at the franchised store during a process of a user making a payment at the franchised store, the user hands over a mobile phone in which a coupon management App is installed to the store owner.

In operation S1002, the coupon server may receive the admin code from the store owner through the coupon management App installed in the mobile phone of the user. In operation S1003, the coupon server may verify whether a coupon of the franchised store is registered to a coupon list of the user after identifying the franchised store through the admin code and identifying the user through the coupon management App into which the admin code is input.

In operation S1004, when the coupon of the franchised store is not registered, the coupon server may generate a coupon issued from the franchised store in the coupon list of the user. In operation S1005, the coupon server may accumulate a stamp into the corresponding coupon in a state in which the coupon of the franchised store is registered.

Thus, according to embodiments, the store owner may directly accumulate a stamp into the coupon of the user using the admin code.

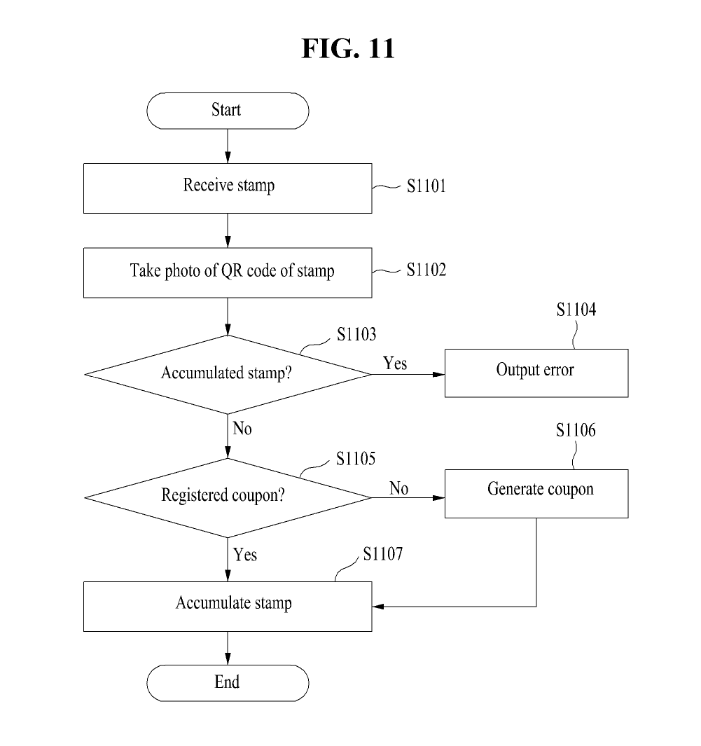

FIG. 11 is a flowchart illustrating a method of receiving, by a user, and accumulating a stamp at a franchised store.

In operation S1101, a user visiting a franchised store receives a stamp provided from the franchised store during a payment process. For example, a stamp may be transferred to the user by printing a QR code issued from a coupon server in a form of a sticker at the franchised store. As another example, the coupon server may wait for an interaction with a receipt output system of the franchised store and may output a QR code on a receipt when the receipt is output during a payment process.

In operation S1102, the user takes a photo of the QR code in the stamp received through the sticker or the receipt using a coupon management App installed in a mobile phone of the user. Here, the coupon management App includes a code recognition function.

In operations S1103 and S1104, when the QR code of the stamp is input through the coupon management App installed in the mobile phone of the user, the coupon server may verify whether the stamp is an already accumulated stamp and may output an error for an invalid stamp.

In operation S1105, when the stamp of the QR code is a valid stamp, the coupon server verifies whether the coupon of the franchised store is registered to a coupon list of the user. In operation S1106, when the coupon of the franchised store is not registered, the coupon server may generate a coupon issued from the franchised store in the coupon list of the user. In operation S1107, the coupon server may accumulate a stamp into the corresponding coupon in a state in which the coupon of the franchised store is registered.

Thus, according to embodiments, the user may directly input a QR code of a stamp received offline into the coupon server through the coupon management App, and may accumulate the stamp into the coupon of the user.

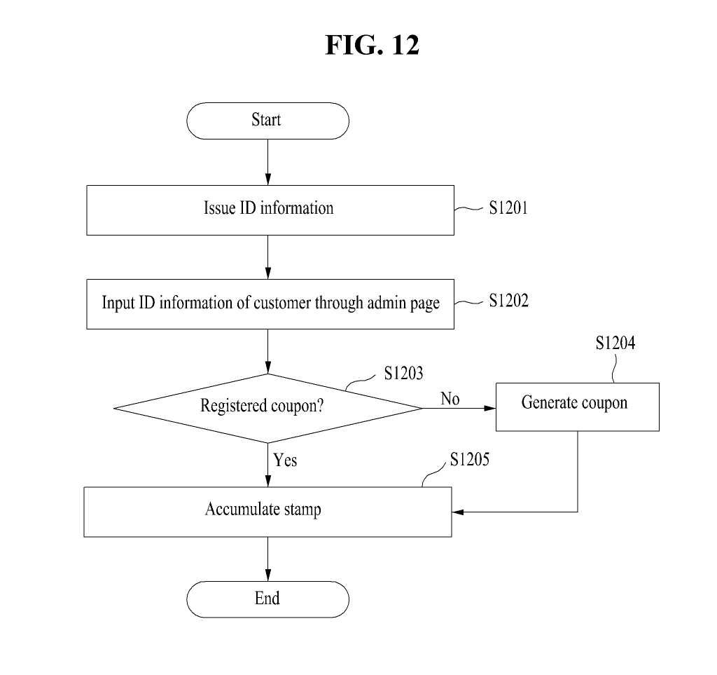

FIG. 12 is a flowchart illustrating a method of accumulating, by a store owner, a coupon using an individual ID of a user.

In operation S1201, a coupon server may provide a coupon management App that is an application exclusive for a cumulative coupon service, and may issue ID information for identifying a user when the user installs the coupon management App into a mobile phone of the user. In this example, an ID, a QR code, and a barcode may be used for the ID information.

To accumulate a stamp provided from a franchised store during a process of a user making a payment at the franchised store, a user may inform a store owner of ID information of the user and the store owner may input the ID information of the user through an admin page provided from the coupon server.

In operation S1202, the coupon server may receive ID information of the user from the store owner through the admin page of the store owner. In operation S1203, the coupon server may identify the user based on the ID information received from the shop owner, and may verify whether a coupon of the franchised store is registered to a coupon list of the user.

In operation S1204, when the coupon of the franchised store is not registered, the coupon server may generate a coupon issued from the franchised store in the coupon list of the user. In operation S1205, the coupon server may accumulate a stamp into the coupon in a state in which the coupon of the franchised store is registered to the coupon list of the user.

Thus, according to embodiments, the store owner may accumulate a stamp into a coupon of the user using ID information of the user.

In particular, according to embodiments, there is provided a service that enables a user to share an accumulated coupon and stamp with a friend of the user. The coupon server may provide a function of enabling the user to share an accumulated coupon or stamp with a target user set by the user. In this instance, the user may share a coupon of a predetermined franchised store or may share a portion of stamps accumulated into a coupon. Sharing a coupon may indicate sharing all of the stamps accumulated into the coupon.

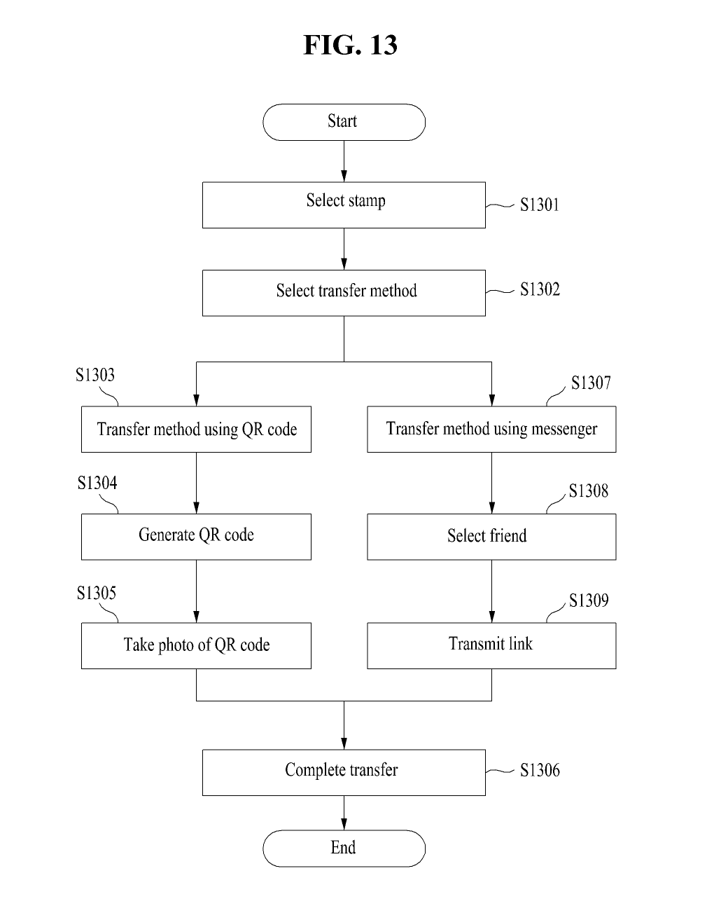

FIG. 13 is a flowchart illustrating a method of transferring, by a user, stamps accumulated into a coupon of the user to a friend.

In operation S1301 and S1302, a coupon server may provide a franchised store list, that is, a coupon list in which at least one stamp is accumulated through a coupon management App installed in a mobile phone of a user in response to a request of the user, and may receive a selection of the user on a stamp to be shared and a transfer method.

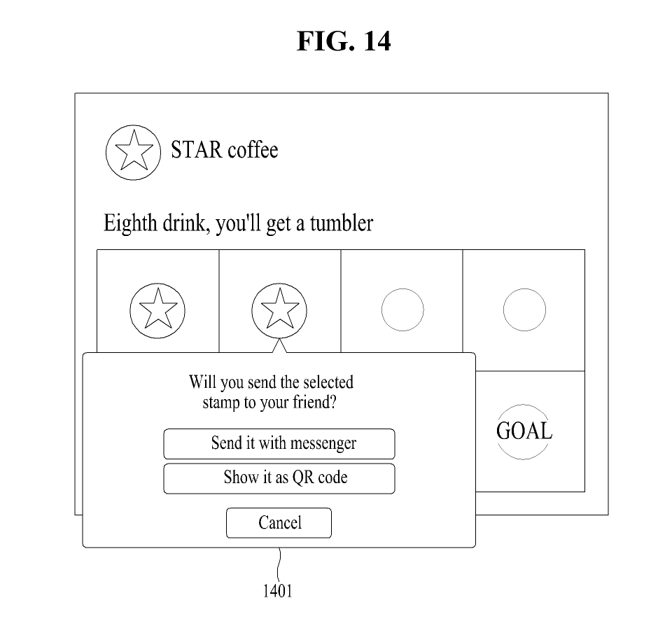

Referring to FIG. 14, when a user selects a predetermined coupon on a coupon list, stamps accumulated into the coupon may be displayed. When the user selects a stamp to be shared, a popup screen 1401 for receiving a selection on a transfer method is displayed. In this instance, a ‘send a message’ menu associated with a transfer method using a messenger and a ‘show a QR code’ associated with a transfer method using a QR code may be activated.

When the user selects the transfer method using the QR code in operation S1303, the coupon server may generate the selected stamp using the QR code and may display the generated QR code on a mobile phone screen of the user in operation S1304. In operations S1305 and S1306, when a target user to which the stamp of the user is to be transferred takes a photo of the QR code displayed on the mobile phone of the user through a coupon management App installed in the mobile phone, the coupon server completes a transfer by recognizing the QR code, by deleting the corresponding stamp from the coupon of the user, and by accumulating the stamp into a coupon of the target user.

When the user selects the transfer method using the messenger in operation S1307, the coupon server may receive a selection on a target user to which the stamp is to be transferred from a buddy list registered to a messenger through interaction between the coupon management App and the messenger in operation S1308. In operation S1309, the coupon server may transfer a link to the stamp to the messenger and the messenger may transmit the link to the target user selected by the user. In operation S1306, when the target user accesses the link to the stamp, the coupon server completes the transfer by deleting the stamp from the coupon of the user and by accumulating the stamp into the coupon of the target user.

According to embodiments, the user may further readily share an accumulated coupon or stamp with a friend using a method of transmitting a coupon or a stamp to the friend using a messenger platform and a method of converting the coupon or the stamp to a QR code and transferring the coupon or the stamp to a friend next to the user.

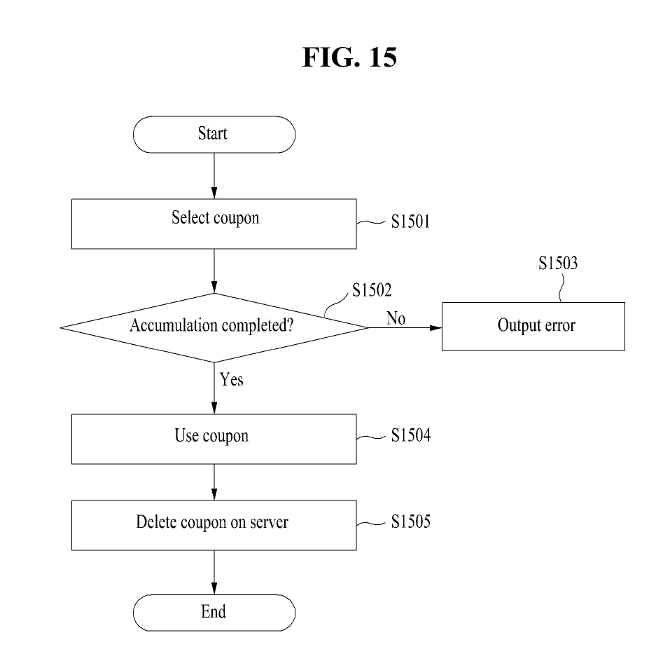

FIG. 15 is a method of using, by a user, an accumulated coupon or mileage.

In operation S1501, a coupon server may provide a franchised store list, that is, a coupon list in which at least one stamp is accumulated through a coupon management App installed in a mobile phone of a user in response to a request of the user, and may receive a selection of the user on a coupon to be used.

In operation S1502, the coupon server may verify whether the number of stamps required for providing a benefit is accumulated into the coupon selected by the user. That is, the coupon server may determine whether the number of stamps accumulated into the coupon of the user has reached the “number of stamps required for benefit’ set by a store owner.

In operation S1503, when the number of stamps required is not accumulated into the coupon of the user, the coupon server outputs an error through the coupon management App installed in the mobile phone of the user. Conversely, when the number of stamps is accumulated, the coupon server allows a coupon use and deletes the coupon on a server in operations S1504 and S1505.

Further, the coupon server may provide coupon management information to the user. For example, the coupon server may provide a franchised store list in which at least one stamp is collected, that is, accumulated through the coupon management App installed in the mobile phone in response to a request of the user, and may provide current state information or details information about a stamp for each franchised store included in the franchised store list. Here, the current state information may include, for example, the number of stamps accumulated into a coupon of a corresponding franchised store, time information about a time at which each stamp is accumulated, or store information. The details information may include, for example, time information about a time at which a stamp is used or store information, and time information about a time at which a stamp is transferred or a name of a target user.

Further, the coupon server may provide coupon management information to a store owner of a franchised store. For example, the coupon server may provide statistical information about a coupon or a stamp through a registered admin page of the franchised store. For example, the coupon server may provide a history graph indicating the number of cumulative coupons issued to a user based on a predetermined period, such as one week, two weeks, one month, three months, and one year.

According to embodiments, it is possible to provide overall information required for coupon management to the store owner of the franchised store and the user.

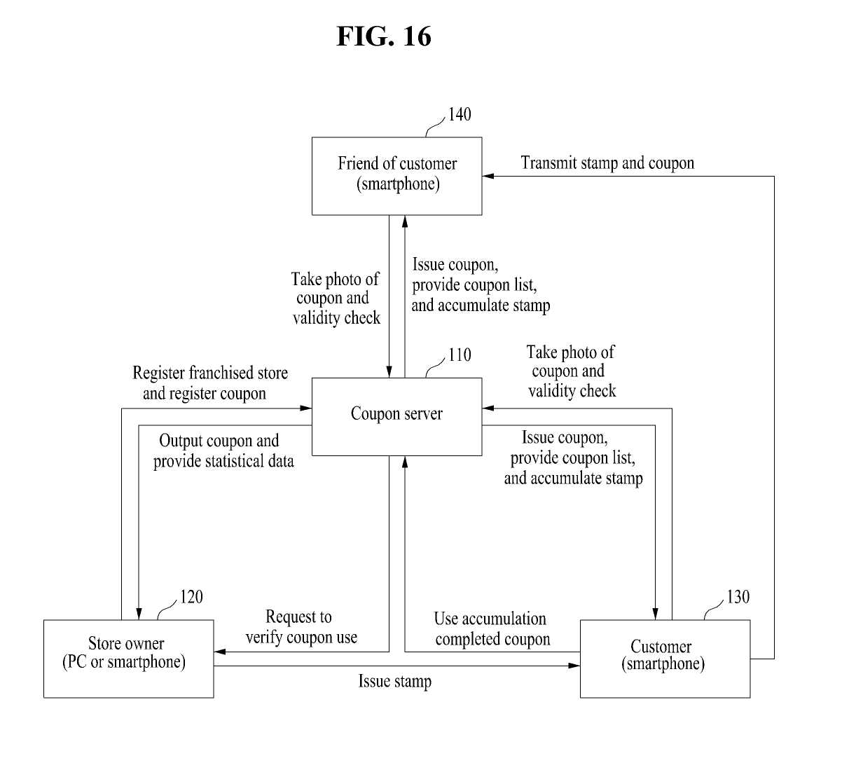

FIG. 16 is a block diagram illustrating an overall system configuration for a cumulative coupon service.

The coupon server 110 may provide the store owner 120 with a function of registering a franchised store and registering a coupon available at the franchised store. Further, the coupon server 110 may provide a function of issuing a stamp code or an admin code for coupon accumulation and a function of providing statistical information about a coupon or a stamp.

The coupon server 110 may provide the customer 130 of the franchised store with an overall function for coupon accumulation and management, such as issuing a coupon, providing a coupon list, and accumulating a stamp. Here, the coupon server 110 may provide an accumulation function using at least one method among a coupon accumulation method using taking a photo of a QR code, a coupon accumulation method using an admin code, and a coupon accumulation method using an individual ID. The coupon server 110 may support a validity check regarding whether a stamp to be accumulated into a coupon is an already accumulated stamp. When the customer 130 is to use the accumulation completed coupon, the coupon server 110 may request the store owner 120 of the franchised store to verify whether the customer 130 is to use the coupon.

In particular, the coupon server 110 may provide a function that enables the customer 130 of the franchised store to share the accumulated coupon or stamp with a friend 140 of the customer 130. In this instance, the coupon server 110 may support the customer 130 to further readily share the coupon or the stamp of the customer 130 with the friend 140 using any of a method of transmitting a coupon or a stamp using a messenger platform and a method of converting and thereby transferring a coupon or a stamp to a QR code. Further, the coupon server 110 may support the validity check about a coupon or a stamp of the customer 130 during a process of transmitting the coupon or the stamp to the friend 140.

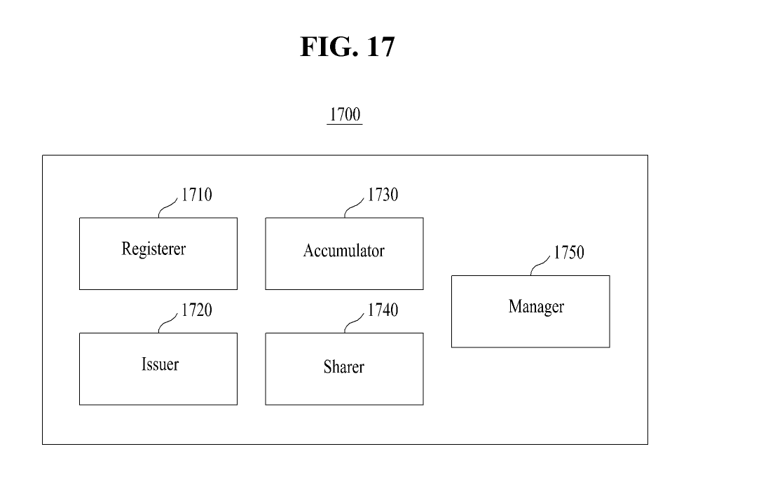

FIG. 17 is a block diagram illustrating a configuration of a coupon server that is a cumulative coupon service providing system according to an embodiment. Referring to FIG. 17, the coupon server 1700 may include a registerer 1710, an issuer 1720, an accumulator 1730, a sharer 1740, and a manager 1750.

The registerer 1710 serves to register a franchised store and a coupon of a store owner, and may receive necessary information from the store owner through an admin page and may register the franchised store and the coupon of the store owner. For example, the registerer 1710 may receive information including a franchised store name, an address and a telephone number of the franchised store, a store at which the coupon is available, a coupon benefit, the number of stamps required for benefit, a logo image of the franchised store or a product image associated with the benefit, and a coupon type, and may register a virtual coupon issued from the franchised store on a server.

The issuer 1720 serves to issue information required to accumulate a stamp into a coupon of the franchised store owned by a user. For example, the issuer 1720 may issue an admin code associated with the franchised store. A method of inputting, by the store owner of the franchised store, inputting the admin code through a mobile phone of the user and accumulating a stamp into a coupon of the user may be applied. As another example, the issuer 1720 may issue a large amount of QR codes functioning as a stamp with respect to a coupon registered by the store owner, in response to a request from the store owner. A method of issuing, by the store owner, a QR code printed in a form of a sticker to customers and accumulating, by each costumer, the stamp into a coupon of a corresponding customer directly through a QR code recognition may be applied. As another example, the issuer 1720 may wait for an interaction with a receipt output system of the franchised store and may issue a QR code on a receipt when the receipt is output during a payment process. A method of issuing, by the store owner, the receipt on which the QR code is printed to a customer and accumulating, by the customer, the stamp into a coupon of the customer may be applied. As another example, the issuer 1720 may issue ID information for identifying a user in a form of an ID, a QR code, and a barcode, to the user having installed a coupon management App in the mobile phone of the user. A method of inputting, by the store owner, ID information of the user through the admin page and accumulating a stamp into the coupon of the user may be applied.

The accumulator 1730 serves to accumulate a stamp into a coupon of the franchised store owned by the user. For example, when an admin code issued for the franchised store is input through a coupon management App installed in the mobile phone of the user, the accumulator 1730 may accumulate the stamp into a franchised store coupon of the user. As another example, when a QR code issued to the franchised store is input through the coupon management App installed in the mobile phone of the user, the accumulator 1730 may accumulate a stamp into a franchised store coupon of the user. As another example, when ID information issued to an individual user is input through an admin page of a store owner of the franchised store, the accumulator 1730 may accumulate a stamp into a franchised store coupon of the user.

The sharer 1740 serves to share a coupon or a stamp accumulated by the user with a target user set by the user. For example, the sharer 1740 may transfer a coupon or a stamp of the user to a target user using a QR code. For example, the sharer 1740 may generate a coupon or a stamp selected by the user as a QR code, and may output the QR code on the mobile phone of the user, and when the generated QR code is input through a coupon management App installed in a mobile phone of a target user, may accumulate the coupon or mileage of the user recognized as the QR code into the coupon of the target user. As another example, the sharer 1740 may transfer a coupon or a stamp of the user to a target user in interaction with a messenger platform. For example, the sharer 1740 may receive a selection on a target user from a buddy list registered to a messenger, may transfer a link to a coupon or a stamp to be transferred by the user to the messenger, and when the messenger transmits the link to the selected target user and the target user accesses the link, may accumulate the coupon or mileage of the user into a coupon of the target user.

The manager 1750 serves to provide coupon management information associated with the user and coupon management information associated with the store owner. For example, the manager 1750 may provide a franchised store list in which at least one stamp is collected, that is, accumulated through the coupon management App installed in the mobile phone of the user in response to a request of the user, and may provide current state information or details information about a stamp for each franchised store included in the franchised store list. Here, the current state information may include, for example, the number of stamps accumulated into a coupon of a corresponding franchised store, time information about a time at which each stamp is accumulated, or store information. The details information may include time information about a time at which a stamp is used or store information, and time information about a time at which a stamp is transferred or a name of a target user name. As another example, the manager 1750 may provide statistical information about a coupon or a stamp through a registered admin page of the franchised store. For example, the manager 1750 may provide a history graph indicating the number of cumulative coupons issued to the user based on a predetermined period, such as one week, two weeks, one month, three months, and one year, and may provide information available for franchised store marketing. Further, the manager 1750 may manage a reward to be provided based on a coupon accumulation state of the user. For example, when the user is to use a coupon, the manager 1750 may verify whether the number of stamps required for providing a benefit is accumulated into a corresponding coupon and thereby provide a feedback to the user. When the user is to use the accumulation completed coupon, the manager 1750 may request the store owner of the franchised store to verify whether the user is to use the coupon.

According to the aforementioned configuration, the embodiments may provide a digitalized cumulative coupon service capable of providing the convenience in coupon management on the side of a customer and providing the convenience in coupon distribution and store promotion on the side of an owner of a franchised store.

As described above, according to embodiments of the present invention, it is possible to enable a cumulative coupon to be further readily shared between users and thereby activate a coupon use by transmitting a coupon or a stamp to a friend in interaction with a messenger platform. Further, according to embodiments of the present invention, it is possible to further easily expand a service using a coupon by providing various types of coupons such as applying a product image as a background image of a coupon or providing a coupon including an advertisement.

The methods according to embodiments of the present invention may be configured in a form of a program instruction executable through a variety of computer systems and thereby recorded in non-transitory computer-readable storage media. In particular, the embodiments may include non-transitory computer-readable media storing a program including accumulating a mileage provided from a franchised store into a coupon associated with the franchised store for a user, and sharing the coupon or the mileage with a target user set by the user. For example, the sharing of the coupon or the mileage may include transmitting the coupon or the mileage to the target user selected from a buddy list registered to a messenger in interaction with a messenger platform, and accumulating a mileage accumulated in the received coupon or the received mileage into a coupon of the target user in response to the target user receiving the coupon or the mileage through the messenger.

A program according to the embodiments may be configured as a PC-based program or an application exclusive for a mobile terminal. The coupon management App according to the embodiments may provide a function of accumulating a stamp into a coupon through an input of an admin code or a QR code recognition, a function of providing a list of coupons in which at least one stamp is accumulated, a function of sharing a coupon or a stamp with a friend, a function of displaying an accumulation state or a use state for each coupon, and a function of playing back content included in a coupon. Further, the coupon management App according to the embodiments may be configured as an independently operating program or may be configured in an in-app form of a predetermined application, for example, a messenger program to be operable on the application.

The non-transitory computer-readable media may include, alone or in combination with the program instructions, data files, data structures, and the like. The program instructions recorded in the media may be specially designed and constructed for the purposes, or they may be of the kind well-known and available to those having skill in the computer software arts. Also, the file system may be recorded in the non-transitory computer-readable media.

According to embodiments of the present invention, a coupon or a stamp is transmitted to a friend of a user in interaction with a messenger platform and thus, a cumulative coupon may be further easily shared between users, which may lead to activating a coupon use.

According to embodiments of the present invention, it is possible to further easily expand a service using a coupon by providing various types of coupons such as applying a product image as a background image of a coupon or providing a coupon including an advertisement.

Although the present invention is described by the embodiments and drawings, the present invention is not limited thereto and it will be apparent to those skilled in the art that various modifications and variations can be made in the embodiments without departing from the spirit or scope of the invention.

Thus, it is intended that the embodiments cover the modifications and variations of this invention provided they come within the scope of the appended claims and their equivalents.

What is claimed is:

1. A method of providing a cumulative coupon service, the method comprising:
accumulating a mileage provided from a franchised store into a coupon associated with the franchised store for a user; and
sharing the coupon or the mileage with a target user set by the user.

2. The method of claim 1, wherein the sharing of the coupon or the mileage comprises:
transmitting the coupon or the mileage to the target user selected from a buddy list registered to a messenger in interaction with a messenger platform; and
accumulating a mileage accumulated in the received coupon or the received mileage into a coupon of the target user in response to the target user receiving the coupon or the mileage through the messenger.

3. The method of claim 1, wherein the sharing of the coupon or the mileage comprises:
outputting the coupon or the mileage in a multi-dimensional code on a terminal of the user; and
accumulating the coupon or the mileage output in the multi-dimensional code into a coupon of the target user in response to the multi-dimensional code input through an application installed in a terminal of the target user.

4. The method of claim 1, further comprising:
issuing an admin code associated with the franchised store,
wherein the accumulating of the mileage comprises accumulating the mileage into the coupon of the user in response to the admin code input through an application installed in a terminal of the user.

5. The method of claim 1, further comprising:
issuing a multi-dimensional code associated with the mileage,
wherein the accumulating of the mileage comprises accumulating the mileage into the coupon of the user in response to the multi-dimensional code input through an application installed in a terminal of the user.

6. The method of claim 5, wherein the issuing of the multi-dimensional code comprises outputting the multi-dimensional code on a receipt in interaction with a receipt output system of the franchised store.

7. The method of claim 1, further comprising:
issuing identification information of the user,
wherein the accumulating of the mileage comprises accumulating the mileage into the coupon of the user recognized based on the identification information in response to the identification information input through an admin page associated with the franchised store.

8. The method of claim 1, further comprising:
providing a franchised store list in which the mileage is accumulated through an application installed in a terminal of the user; and
providing current state information or details information about the mileage for each franchised store included in the franchised store list.

9. The method of claim 1, further comprising:
providing statistical information about the coupon or the mileage through an admin page associated with the franchised store.

10. The method of claim 1, further comprising:
registering a coupon associated with the franchised store through an admin page associated with the franchised store.

11. The method of claim 10, wherein the registering of the coupon associated with the franchised store comprises setting any one coupon type among a basic type of giving a reward in response to the mileage reaching an accomplishment level or a threshold level before the achievement level through the admin page, a customized type of applying a product image associated with the franchised store as a background page of the coupon or the mileage, and an advertising type of providing advertisement content associated with the franchised store through the coupon.

12. A system for providing a cumulative coupon service, the system comprising:
an accumulator configured to accumulate a mileage provided from a franchised store into a coupon associated with the franchised store for a user; and
a sharer configured to share the coupon or the mileage with a target user set by the user.

13. The system of claim 12, wherein the sharer is configured to transmit the coupon or the mileage to the target user selected from a buddy list registered to a messenger in interaction with a messenger platform, and
the accumulator is configured to accumulate a mileage accumulated in the received coupon or the received mileage into a coupon of the target user in response to the target user receiving the coupon or the mileage through the messenger.

14. The system of claim 12, wherein the sharer is configured to output the coupon or the mileage in a multi-dimensional code on a terminal of the user, and
the accumulator is configured to accumulate the coupon or the mileage output in the multi-dimensional code into a coupon of the target user in response to the multi-dimensional code input through an application installed in a terminal of the target user.

15. The system of claim 12, further comprising:
an issuer configured to issue an admin code associated with the franchised store,
wherein the accumulator is configured to accumulate the mileage into the coupon of the user in response to the admin code input through an application installed in a terminal of the user.

16. The system of claim 12, further comprising:
an issuer configured to issue a multi-dimensional code associated with the mileage,
wherein the accumulator is configured to accumulate the mileage into the coupon of the user in response to the multi-dimensional code input through an application installed in a terminal of the user.

17. The system of claim 12, further comprising:
an issuer configured to issue a multi-dimensional code associated with the mileage on a receipt in interaction with a receipt output system of the franchised store,
wherein the accumulator is configured to accumulate the mileage into the coupon of the user in response to the multi-dimensional code input through an application installed in a terminal of the user.

18. The system of claim 12, further comprising:
an issuer configured to issue identification information of the user,
wherein the accumulator is configured to accumulate the mileage into the coupon of the user recognized based on the identification information in response to the identification information input through an admin page associated with the franchised store.

19. The system of claim 12, further comprising:
a manager configured to provide a franchised store list in which the mileage is accumulated through an application installed in a terminal of the user, and thereby provide current state information or details information about the mileage for each franchised store included in the franchised store list, or provide statistical information about the coupon or the mileage through an admin page associated with the franchised store.

20. The system of claim 12, further comprising:
a registerer configured to register a coupon associated with the franchised store through an admin page associated with the franchised store.

21. Non-transitory computer-readable storage media comprising an instruction to control a computer system to provide a digitalized cumulative coupon service, wherein the instruction controls the computer system by a method comprising:
accumulating a mileage provided from a franchised store into a coupon associated with the franchised store for a user; and
sharing the coupon or the mileage with a target user set by the user, and
the sharing of the coupon or the mileage comprises:
transmitting the coupon or the mileage to the target user selected from a buddy list registered to a messenger in interaction with a messenger platform; and
accumulating a mileage accumulated in the received coupon or the received mileage into a coupon of the target user in response to the target user receiving the coupon or the mileage through the messenger.
